(19) United States
(12) Patent Application Publication
(10) Pub. No.: US 2007/0290600 A1
(43) Pub. Date: Dec. 20, 2007

(54) Flat fluorescent lamp with large area uniform luminescence

(75) Inventors: Mark D. Winsor, Chehalis, WA (US); James G. Flynn, Vader, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Winsor Corporation, Chehalis, WA (US)

(21) Appl. No.: 11/453,561

(22) Filed: Jun. 15, 2006

(51) Int. Cl. H01J 1/62

(52) U.S. Cl. 313/493

(57) ABSTRACT

A lamp includes a plurality of channels filled with a gas. Electrodes are disposed adjacent to each of the plurality of channels to create respective paths for electrical discharge within the gas of each channel. A gas permeable passage is positioned between adjacent channels and permits a passage of gas molecules between adjacent channels while the electrical discharge is blocked between the plurality of channels.

### TECHNICAL FIELD

The invention generally relates to planar photoluminscent lamps, and more particularly, to a photoluminscent lamp with individual electrical discharge channels atmospherically connected together to allow for uniform luminescence over a large area.

### BACKGROUND OF THE INVENTION

Thin, planar, and relatively large area light sources are needed in many applications such as, for example, backlighting LCD (Liquid Crystal Display). Because of low light transmission in typical active matrix liquid crystal displays (LCD), very thin and powerful backlights are required to preserve a thin profile and readability in high ambient lighting conditions. LEDs (Light Emitting Diodes) create local bright and dim areas because of the nature of point light sources as used in backlighting. Additionally, significant heat dissipation in LEDs restrict use in some high performance applications.

Some LEDs have a larger color gamut compared to general lighting fluorescent lamps. The color of the RGB (Red, Green, Blue) LEDs are mixed into broadband light and the wavelengths change over time. This technical problem demands complicated sensor and correction technology to keep the color balanced.

LED technology is presently the most costly of all light sources considered to be practical for long life TV backlighting (>50 khrs to half brightness).

Cold cathode fluorescent lamps (CCFL) are very small diameter fluorescent tubes which are placed in a reflective box as the backlight. Presently, they represent the majority of the TV backlighting light sources market. Typically the TV area size has a 16:9 aspect ratio. TV backlights often position the straight CCFL tubes into rows leaving an unoccupied space in between.

The CCFLs are placed in the box with their long axis in conjunction with the long axis of the backlight box. The TV is typically placed to operate on a vertical wall in the home and the tubes at the bottom of the box operate at a temperature less than the tubes near the top of the box.

This reduces the lifetime of the top tubes as the mercury vapor which produces the visible light in most CCFLs is at a higher pressure than the colder tubes below. As is generally known and described by low pressure plasma discharge physics, the efficacy of the fluorescent lamp is determined by the mercury vapor pressure. The mercury vapor produce UV light after ionization and radiate the phosphors. The vapor pressure being controlled by the lamps coldest spot. The CCFL tubes are modeled as a linear light source, which require considerable diffusion of the bright lines of light versus the dim areas in the box.

The tubes need to be about 1.5 mm ID to produce the intense brightness required to compensate for the light diffusion of the linear sources. The very high current density of the CCFL source quickly degrades the rare earth phosphor output and chromaticity.

CCFLs can have color gamuts wider than typical fluorescent lamps by the addition of other phosphor wavelengths to the standard RGB mixture to complement the LCD filter transmission. With the addition of a fourth or fifth phosphor material to the standard RGB mixture the CCFL then does not have a disadvantage to the LED backlight gamut.

We have disclosed flat fluorescent lamps (FFL), monolithic and tiled fluorescent lamps as an alternative LCD backlighting technology. Various improvements have been made to the state of the art of high performance display lighting.

Very high performance FFLs can be extremely bright (33,000 cdm2) and also have large dimming ratios as described in U.S. Pat. No. 6,876,139 to Olson.

Monolithic FFLs have the advantage of uniform light emission across the lamps surface area without the associated dark areas of tiled lamp assemblies. The most efficient designs are long serpentine discharge channeled designs and utilize cathodes placed outside of the display active area.

Like the most efficient fluorescent tube lamps known, these FFLs use only a few milligrams of mercury vapor to produce intense UV energy at 2-70 torr of inert gas pressure.

The flat serpentine lamp has the highest possible lumens per watt efficacy as only two cathodes and their associated voltage losses are amortized across a very large surface area of light emitting lamp. A serpentine lamp of infinite length would have theoretically the maximum lumen efficacy possible for a FFL.

A FFL design, disclosed in U.S. Pat. No. 5,343,116, utilizes additional electrode pairs at the ends of each of the serpentine channels, to add energy to the plasma, which reduces energy required by the two primary cathodes. This design can aid in the reduction of power required by the main cathodes in large area serpentine lamps. The slow migration of the mercury vapor until reaching equilibrium, slows the ability to warm-up quickly without other means. Limits its use as a very large area light source. Additionally, it is more expensive to make as a glass part in high speed production. The serpentine design is not easily drawn into the convoluted shape. U.S. Pat. No. 6,301,932 allows the production of a single piece lamp envelope. The single piece glass envelope is more efficiently made without frit sealing two glass plates.

But every individual size then requires a specific mold or tooling change, negatively affecting the FFL price.

Additionally, very high electrical field strengths associated with very long discharge channels can inject mercury atoms into the serpentine glass walls of each corner. The capacitive current displaced across the divider wall is high near the corner dividing walls. This area is under the influence of the highest electrical fields, after the cathode fall area.

Furthermore, additional mercury vapor control down each channel must be regulated to keep the pressure nearly equally by a more complicated means in very long discharge monolithic lamps. Often they are too high in start and run voltage to be used practically in all sizes.

Several flat TV technologies are competing for the largest share of this growing market segment which is driven by falling consumer cost for plasma and rear projection. LCD TVs must continue to be cost competitive and the backlight is the single most expensive component in the display system.

As the surface area of the LCD TV has increased dramatically over a short period of a few years time, a new, very large lamp design is required which is not limited to increasing display sizes.

Recent advances in photoluminescent technology have met the demand for a thin, lightweight, planar lamp having a substantially uniform and durable display. One such fluorescent lamp is described in U.S. Pat. No. 6,762,556, filed on Feb. 27, 2001. The lamp comprises a pair of glass plates connected by a sidewall, thereby creating an open chamber, which contains a gas and photoluminescent material. Electrodes are placed on the outside of the glass plates to create an electric field inside the chamber, which ionizes the gas and causes the photoluminescent material to emit visible light. The lamp can be inexpensively built to any size but suffers from lower lumens per watt from the very short micro-arc discharges produced at inert gas backfill pressures of half an atmosphere and less efficiently capacitively driven electrodes.

There remains a need for a thin, lightweight, lamp having a substantial uniform display that is easily manufacturable, is readily scaleable to larger display sizes, is temperature tolerant, and is relatively durable.

### SUMMARY OF THE INVENTION

According to one aspect, a lamp includes a plurality of channels filled with an inert gas and mercury vapor, electrodes disposed adjacent to each of the plurality of channels to create respective paths for electrical discharge within the gas of each channel, and a gas permeable passage positioned between adjacent channels that permits passage of gas and vapor molecules between the adjacent channels while the electrical discharge is blocked between the plurality of channels.

According to another aspect, a lamp includes a plurality of channels filled with a gas, means for creating paths for electrical discharge within the respective plurality of channels, and means for permitting a passage of gas molecules between adjacent channels while the electrical discharge is blocked between the plurality of channels.

According to another aspect, a method for providing uniform illumination across a lamp includes blocking electrical discharge between a plurality of channels, and atmospherically connecting the plurality of channels to permit a passage of gas molecules between adjacent channels.

According to another aspect, a method for providing uniform mercury vapor pressure across all channels.

According to another aspect, a method for providing electrical current through the lamp by internal electrode emission or by externally capacitively coupled electrodes.

According to another aspect, a method for providing a reduced voltage drop across a large lamp surface.

According to another aspect, a lamp channel design without high capacitance between the discharge of each channel to another.

### BRIEF DESCRIPTION OF THE DRAWINGS

In the drawings, identical reference numbers identify similar elements. The sizes and relative positions of elements in the drawings are not necessarily drawn to scale.

FIG. 1A is an isometric view of a lamp without showing the sidewalls to provide a view of a set of holes penetrating a bottom plate, according to one embodiment of the invention.

FIG. 1B is a cross section of the lamp of FIG. 1A, according to one embodiment of the invention.

FIG. 1C is a bottom view of the lamp of FIG. 1A with a tip-off tube, according to one embodiment of the invention.

FIG. 1D is a bottom view of a unitary structure of the lamp of FIGS. 1A-1C without showing extruding coverings, electrodes and a grounded conductive layer, to provide a better view of the unitary structure and sets of holes therein, according to one embodiment of the invention.

FIGS. 1E-1G are partial cross sectional views of the unitary structure of FIG. 1D, according to other illustrated embodiments.

FIG. 2A is an isometric view of a fluorescent lamp without showing sidewalls to provide a view of two sets of holes penetrating a bottom plate and a view of a removed portion of a photoluminescent layer, which forms a gas permeable passage, according to one embodiment of the invention.

FIG. 2B is a cross section of the lamp of FIG. 2A, according to one embodiment of the invention.

FIG. 2C is a bottom view of the lamp of FIG. 2A with a tip-off tube, according to one embodiment of the invention.

FIG. 3 is a top view of a schematic illustration of electron flow within channels of a lamp, according to one embodiment of the invention.

FIG. 4A is an isometric view of a lamp showing sidewalls without showing end walls, to clearly view a plurality of channels, according to one embodiment of the invention.

FIG. 4B is an isometric view of the lamp of FIG. 4A, showing the end walls without showing the sidewalls of FIG. 4A to clearly view a gas permeable passage, according to one embodiment of the invention.

FIG. 4C is a fragmentary cut away schematic of the fluorescent lamp of FIGS. 4A and 4B including an additional coating of photoluminescent material on a top plate as well as on a bottom plate, according to one embodiment of the invention.

FIGS. 5A and 5B are cross-sections of the lamp taken at a location shown in FIG. 4A, according to one embodiment of the invention.

FIGS. 6A and 6B are cross-sections of the lamp taken at a location shown in FIG. 4A, according to one embodiment of the invention.

FIG. 7 is an isometric illustration of a lamp having a gas permeable passage formed through electrically insulating partitions, according to one embodiment of the invention.

FIGS. 8A and 8B are cross-sections of the lamp of FIG. 7, according to some embodiments of the invention.

FIGS. 9A and 9B are cross sections of the lamp of FIG. 7 having a plurality of gas permeable membranes, according to some embodiments of the invention.

FIG. 10 is a schematic illustration of a fluorescent lamp with discharge paths within gas filled tubes, according to one embodiment of the invention.

FIG. 11 is a cross section schematic of the lamp of FIG. 10, according to one embodiment of the invention.

FIG. 12 is a backside view of the lamp of FIG. 13A showing use as a backlight for an LCD (Liquid Crystal Display), according to one embodiment of the invention.

### DETAILED DESCRIPTION OF THE INVENTION

In the following description, numerous specific details are given to provide a thorough understanding of various embodiments of the invention. The invention, with equivalent structures and methods to those shown and described, can be practiced without one or more of the specific details, or with other methods, components, materials, etc. Well-known structures, materials, or operations are not shown or described in detail which are within the scope of the art and do not form part of this invention.

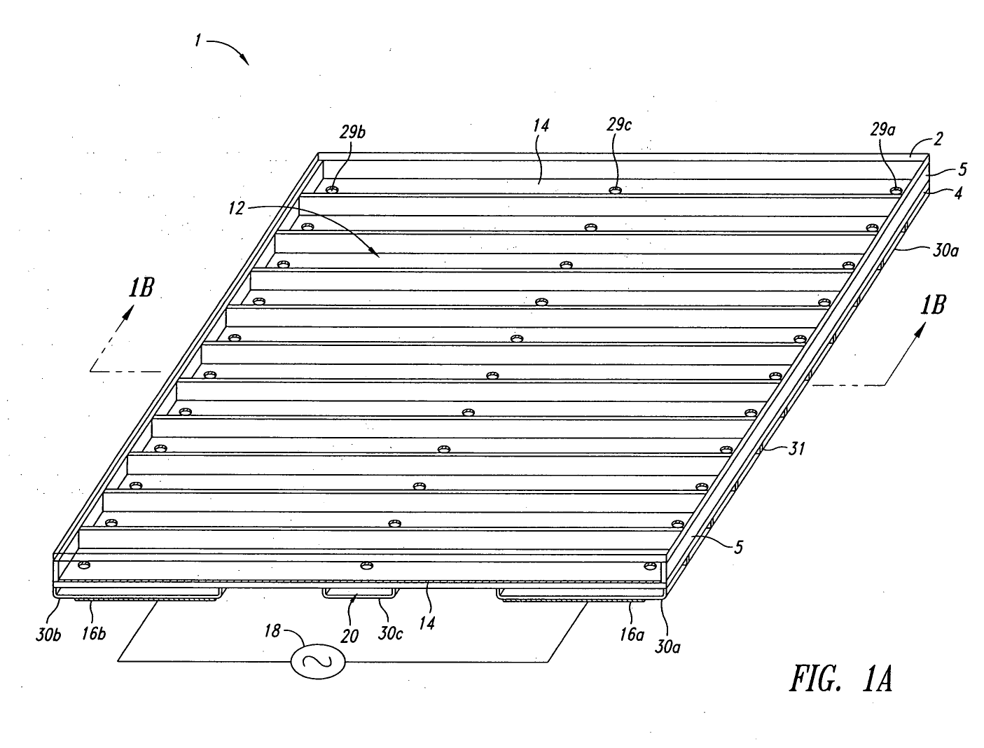

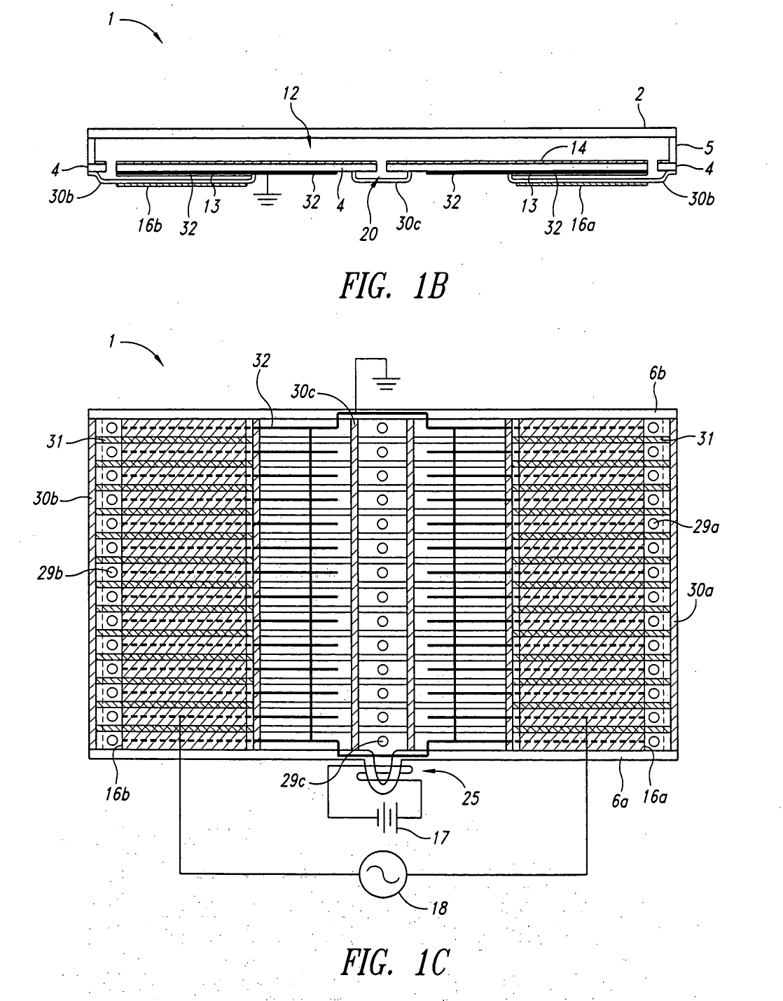

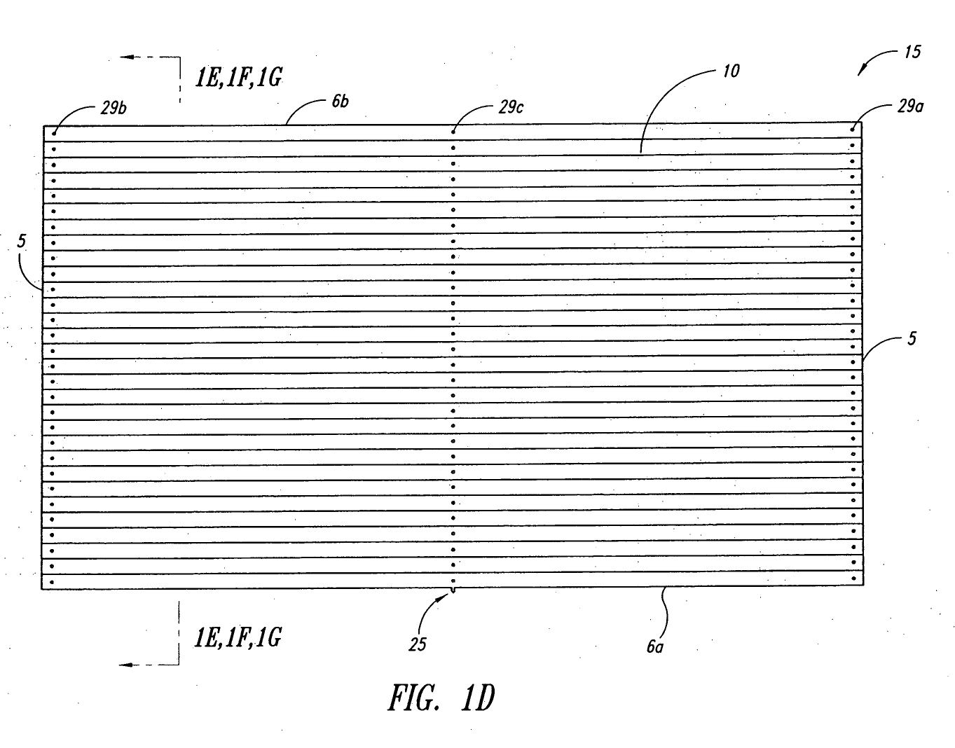

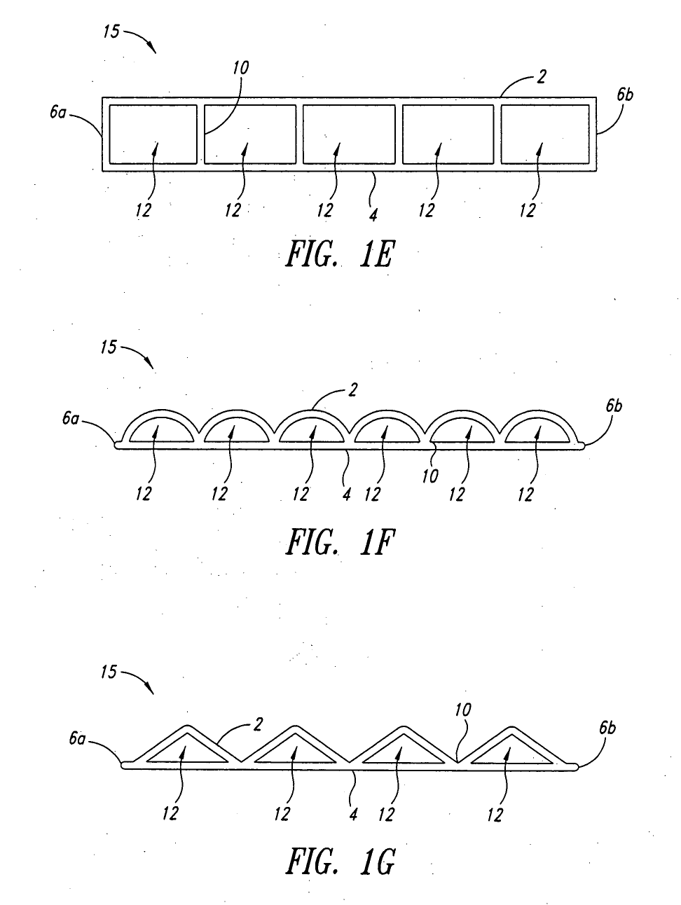

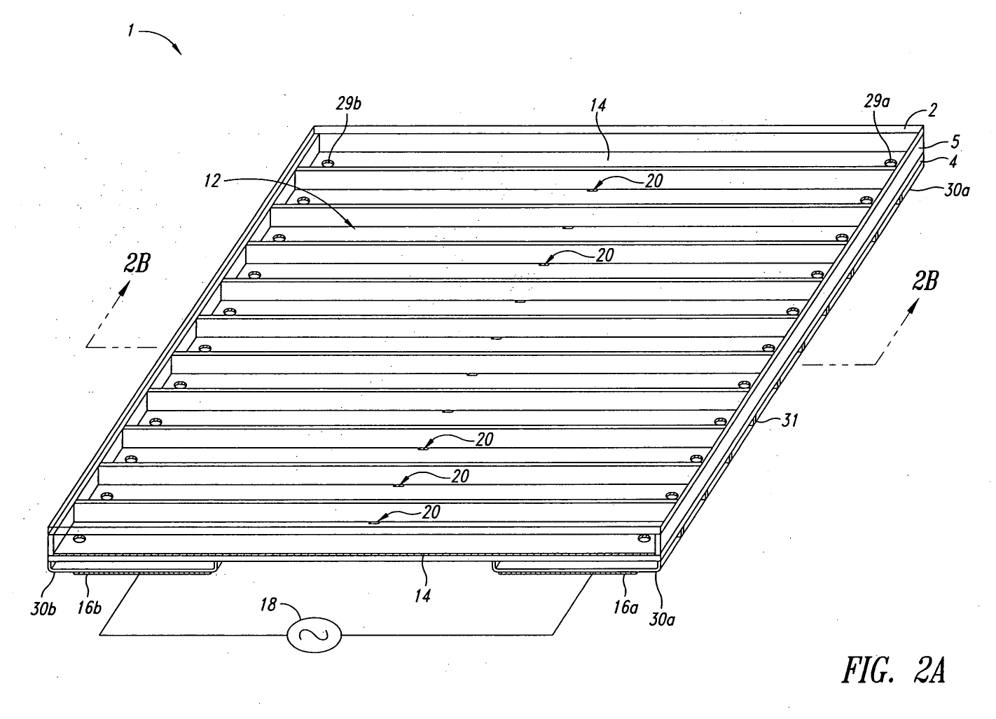

FIG. 1A shows an isometric view of a fluorescent lamp 1 without showing the sidewalls 6a, 6b to provide a view of the sets of holes 29 (collectively referenced as 29 and individually referenced 29a, 29b, 29c) penetrating a bottom plate 4, according to one embodiment. FIG. 1B shows a cross section of the lamp 1 of FIG. 1A while FIG. 1C shows a bottom view of the lamp 1 of FIG. 1A having the tip-off tube 25. Reference is now made to FIGS. 1A-1C.

In one embodiment, the lamp 1 comprises a top plate 2 and the bottom plate 4. The top and bottom plates 2 and 4, respectively, are connected to electrically insulating sidewalls 6 (collectively referenced as 6 and individually referenced as 6a, 6b) and end walls 5 at the peripheral edges 8 of the top and bottom plates 2 and 4, respectively, forming a hermetically sealed chamber. A plurality of electrically insulating partitions 10 extend between the top and bottom plates 2, 4 forming the plurality of discharge channels 12.

The inner surfaces of one or both of the top plate 2 or bottom plate 4 are coated with a photoluminescent material 14. Additionally or alternatively, the surfaces of the electrically insulating partitions 10 may also be coated with the photoluminescent material 14. The photoluminescent material 14 may be, for example, a phosphor layer or any suitable layer for generating visible light energy in response to excitation by ultraviolet (UV) radiation, as is well known in the art.

The hermetic chamber includes an ultraviolet emissive gas. While mercury vapor is commonly used in fluorescent lamps, it is possible to use other gases and chemical vapors to provide the UV energy such as, for example, xenon, krypton, neon, helium, and or with argon, xenon, a mixture of inert halogen gases and the like, either alone or in combination to produce the desired spectral characteristics, all of which are known to those skilled in the art. The ultraviolet emissive gas used in the lamp 1 emits ultraviolet radiation when the gas is electrically excited. The lamp pressure is selected to provide the desired spectral characteristics of the lamp 1 for a given gas or gas and vapor combination, as is known in the art. Accordingly, the embodiments described herein are not limited by the lamp pressure, the type of photoluminescent material 14, the type of gas or gas and vapor combination used to fill the lamp 1.

The lamp 1 of FIGS. 1A-1C comprises three sets of holes (collectively referenced 29 and individually references 29a, 29b, 29c) formed through the bottom plate 4 with each set of holes having a respective extruding covering 30a, 30b, 30c (e.g., glass) on the backside of the lamp 1, disposed along a directional axis that is perpendicular to the channels 12. Extruding coverings 30a and 30b have electrode plates 16a and 16b, respectively, disposed along the outside or inside (not shown) of the extruding covering 30a, 30b along the directional axis perpendicular to the channels 12. Insulating dividers 31 are disposed within the coverings 30a, 30b to electrically divide the electrode plates 16a, 16b so that each channel 12 is electrically isolated from the other. Extruding covering 30c serves as a gas permeable passage 20 that atmospherically connects the plurality of channels 12 along a region 21 of least electrical energy. Covering 30c together with the holes 29c allow the gas pressure to equalize throughout the lamp 1 and allows controlled uniformity of vapor pressure.

Power is supplied to the electrode plates 16a, 16b to create electrical discharge paths within the gas of each channel 12. In some embodiments, a pulsed AC power supply 18 may power the electrodes 16 while in other embodiments a pulsed DC waveform may be converted from low voltage DC power or a continuous wave form is used.

In one embodiment, the carrier waveform is about 20 khz and is pulsed at between 20-400 hertz as required. The secondary of a transformer is a center point ground type. With the center point ground electrically connected to the lamp ground plane and the aluminum heat sink all connected to system ground.

In another embodiment the lamp 1 is pulsed on and off, in relation to the LCD scan rate and aids in reducing blurring artifacts in motion displayed images on the LCD.

According to further embodiments, first and second electrodes (not shown) are disposed along an exterior of the first and second planar plates 2, 4 to create a uniform electric field along each of the plurality of chambers 12 by capacitive coupling through the first and second planar plates 2, 4.

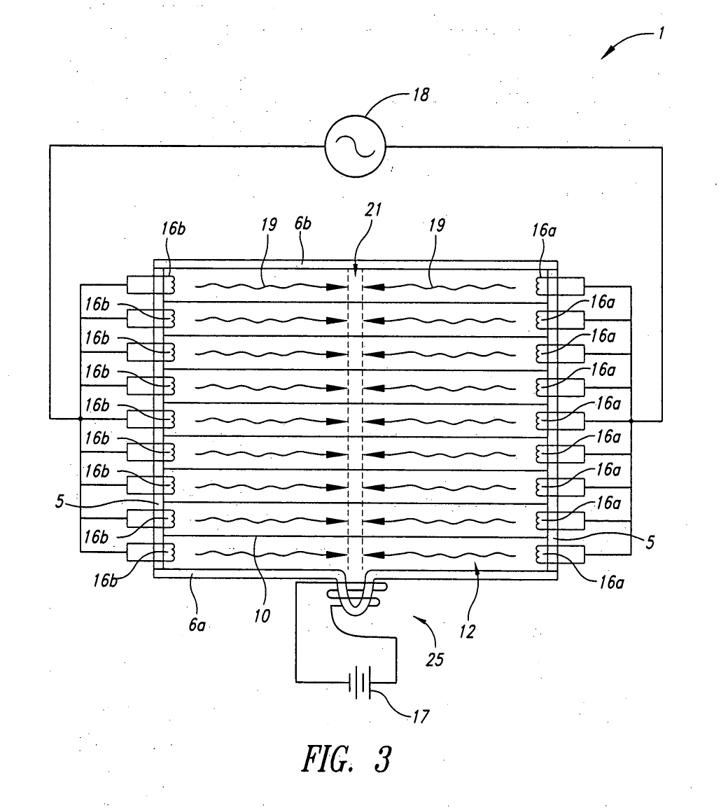

According to some embodiments, the gas permeable passage 20 is positioned between adjacent channels 12 to permit a passage of gas molecules and/or vapor between the adjacent channels 12 while blocking an electrical discharge 19 (FIG. 3) between channels 12. The passage 20 may be formed by the formation of the holes 29c adjacent the region 21 of least electrical energy within each of the plurality of channels 12. The gas and vapor pressure is therefore approximately uniform across the lamp 1. Throughout the entire lamp 1, the gas and vapor pressure is approximately the same in each channel 12 since gas and vapor can pass between the channels 12 to equalize or adjust to local changes that may tend to occur over the life of the lamp 1. Uniform pressure across the lamp 1 aids to provide more uniform light emission from each channel 12 relative to the other channels 12.

For example, the lamp 1 may be positioned in an upright position during use, thereby causing a temperature gradient between the plurality of channels 12 due to the difference in elevation between channels 12. Since heat rises, channels 12 positioned at a higher elevation than others may have a significantly higher internal temperature. In such an upright position, the temperature in each channel 12 is greater than the underlying channel 12, thus forming a temperature gradient as the channels 12 increase in height from sidewall 6a to sidewall 6b (For example, if sidewall 6a is positioned at a lower height than sidewall 6b).

At higher channel 12 temperatures the mercury vapor is driven down toward the cooler regions which reduce the pressure. This increases the pressure in lower channels and substantially equalizes the pressure throughout the lamp 1. With such self regulating vapor pressure means, a minimum quantity of mercury liquid is required in the hermetically sealed lamp 1. Absent a means for allowing the passage of gas and vapor between the channels, those channels 12 with the higher internal temperature would emit more light than channels 12 positioned at a lower height and having a relatively lower internal temperature. This would result in a non-uniform light distribution across the lamp 1.

The gas permeable passage 20 allows for the gas and vapor pressure to appropriately compensate for the temperature gradient across the lamp 1. For example, the gas molecules from a hot channel 12 may diffuse into the cold channel 12 to compensate for the temperature gradient and resulting non-uniformity in light emission between the channels 12. This establishes uniform light emission throughout the lamp 1.

In another embodiment, a thermoelectric device (not shown) may be coupled to the center of the coldest cold channel 12, proximate the sidewall 6a, by heating the cold channel 12 and effectively increasing the internal temperature, thereby raising the vapor pressure and providing light emission comparable to the warmer channels 12. The thermoelectric device may be placed at the center of the bottom channel, (also known as the cold spot of the lamp—the area where the mercury vapor would condense back to the liquid state). If the lamp has ran for a period of time, the mercury vapor will reach equilibrium and condense at the cold spot of a particular lamp. By the heating of the thermoelectric heater, the mercury vapor is flashed into the lamp raising the vapor pressure up through the permeable passage. This allows the lamp 1 to initially start up with uniform illumination without the delay associated with the gradual raise in vapor pressure associated with the plasma discharge heating only.

Once desired vapor gas pressure and uniform light is achieved throughout the lamp 1, the thermoelectric device may function to control the gas pressure and associated light emission by functioning interchangeably as a cooler as well as a heater.

As a further example, when a fluorescent lamp ages, the vapor pressure may be reduced vary slightly as mercury is lost into the lamp coatings or glass walls on the chamber. Also, the gas pressure may become reduced at the cathode area from being trapped between the walls of the chamber and a thin sputtered film associated with cathode operation. If a plurality of channels are adjacent to each other and are hermetically isolated, over time, the vapor and gas pressure in each will gradually change at different rates, thus causing the light emitted to vary. If the channels are adjacent to each other, even minor variations in light emission may be apparent to an observer. Such variations would create dark or light areas in the back light of an LCD and thus would be undesirable in the displayed images.

As described above, one of the applications of the lamp 1, such as a backlight for a flat screen display (shown in FIG. 12), may require the lamp 1 to be in an upright position during use, thereby forming a temperature gradient resulting in a vapor gradient throughout the lamp 1. The mercury vapor atoms tend to accumulate and condensate at the point of least energy (e.g., least light emission) which is away from the highest energy area inside the lamp, near each cathode as is known, within the bottom most channel 12 (e.g., cold channel 12 proximate sidewall 6a) of the lamp 1 near the middle of the channel 6a. The sidewall 6a may have a tip-off tube 25 formed at the point of least electrical energy 21, adjacent passage 20. The tip-off tube 25 is formed after the air is pumped out of the lamp 1 and the gas and mercury is backfilled inside the lamp 1. The gas molecules will tend to accumulate within the cold tip-off tube 25. The tip-off tube 25 may have a resistive wire coiled around the tube 25 that is electrically coupled to a power source 17 (e.g., controller) for heating the tube 25 thereby increasing the vapor pressure and UV energy and light emission of the cold channel 12 to compensate for the temperature gradient throughout the lamp 1a. Thus, light emission throughout the channels 12 of the lamp 1a may remain uniform regardless of the elevation of the channels 12 relative the sidewall 6a.

In the event that the lamp 1 is used for low light applications it may be beneficial to neutralize the electric fields near the electrodes 16a, 16b. Since the electric fields near the electrodes 16a, 16b are higher than at other portions of the channel 12, there may be a noticeably higher illumination near the areas of high electric field (e.g., near the electrodes 16a, 16b) and thus non-uniform light emission across the channel 12. In order to substantially eliminate such non uniformity, the electric field near the electrodes 16a, 16b may be neutralized by having a grounded conductive layer 32 disposed along at least portions of the backside of the bottom plate 4 that correspond to the electrode 16a, 16b. The conductive layer 32 is at least aligned with the electrode 16a, 16b and blocks the electric field from influencing the light emission within the channel 12. An insulator 13 encapsulates at least a portion of the conductive layer 32 that is positioned within the extruding coverings 30a, 30b. The insulator 13 prevents the gas from contacting the grounded conductive layer 32. The insulator 13 may be of electrically insulating material that is similar to the insulating material comprising the lamp 1. The grounded conductive plane 32 may be positioned on the front of the lamp in an alternate design by using a transparent conductor film or grid.

The lamp 1 is preferably formed by high speed extruding the hot glass into a channeled flat ribbon having channel detail corresponding to the desired channels 12 in the lamp 1, as shown in FIGS. 1E-1G. The hot ribbon may be 2 meters across and have a hundred individual channels. A short axis of the channels may be sliced to size with a cuffing technology like hydrogen flame or laser beam. Alternatively the short axis may be cut to size after a longer portion of the ribbon has cooled. The ribbon is then sliced across running perpendicular to the channel 12 length, thereby conforming the ribbon to the dimension required for the long axis of the lamp 1 to serve as an LCD light source, for example. The slicing of the glass into the desired dimensions may be implemented while the glass is hot or after it has cooled. Whether the glass is hot or cold, the ends of a long axis are sealed off using a torch and mechanical pressure. If the glass is cold, the ends of the long axis may be sealed with a frit sealer. The lamp channels 12 can be coated with the luminescent coatings before sealing of the lamp channel ends and the placement of the set of holes 29 across the short axis of the lamp 1.

The three sets of holes 29 may be formed using the torch or the laser or hot pressing when the glass is hot or by drilling or water jet cutting or sandblasting the holes 29 when the glass is at ambient temperature. The holes 29 may be manufactured according to any suitable technique known in the art. The lamp 1 is then internally coated with the photoluminescent material 14 and baked. The coverings 30 are sealed onto the bottom plate 4 using the torch or low-melting point frit. Covering 30c is left with one unsealed opening, which is inserted with the pumping tube for extracting air from the lamp 1 by means of vacuum pumping. Following the vacuum pumping, the pumping tube fills the lamp 1 with the desired gas and mercury source. As the pumping tube is sealed-off from the opening of the covering 30c, the tip-off 25 is formed, as is practiced in the industry.

FIG. 1D shows a bottom view of the lamp 1 of FIGS. 1A-1C without showing the extruding coverings 30, the electrodes 16a, 16b and the grounded conductive layer 32, to provide a view of a unitary structure 15, according to one embodiment. FIGS. 1E-1G show partial cross sectional views of the lamp 1 of FIG. 1D, according to several illustrated embodiments. Reference is made to FIGS. 1D-1G.

According to one embodiment, the top and bottom plates 2, 4, the insulating partitions 10, the sidewalls 6, and the end walls 5 comprise one unit of glass, hereinafter referred to as the unitary structure 15. As illustrated in FIGS. 1E-1G, the lamp 1 may comprise the unitary structure 15 of glass channels 12 such as, for example, borosilicate or aluminosilicate hard type glass. Alternatively, soda lime silicate, also known as float glass, can be conformed to obtain the desired dimension and shape of each of the channels 12. The unitary structure 15 of the lamp 1 may be formed by manipulating hot glass directly from a melting tank and forming a continuous flat ribbon having channel dimensions corresponding to the desired channels 12 in the lamp 1. The ribbon is then sliced along an axis (short axis) running parallel to the channel length, thereby conforming the ribbon into the dimension required for the lamp 1 to serve as an LCD backlight, for example. The slicing of the glass into the desired dimensions may be implemented while the glass is hot or after it has cooled. Whether the glass is hot or cold, the ends of the long axis are sealed off using the torch. If the glass is cold, the ends of the long axis may be sealed off with the frit sealer. The unitary structure 15 and other portions of the lamp 1 may be formed using any suitable manufacturing technique known in the art.

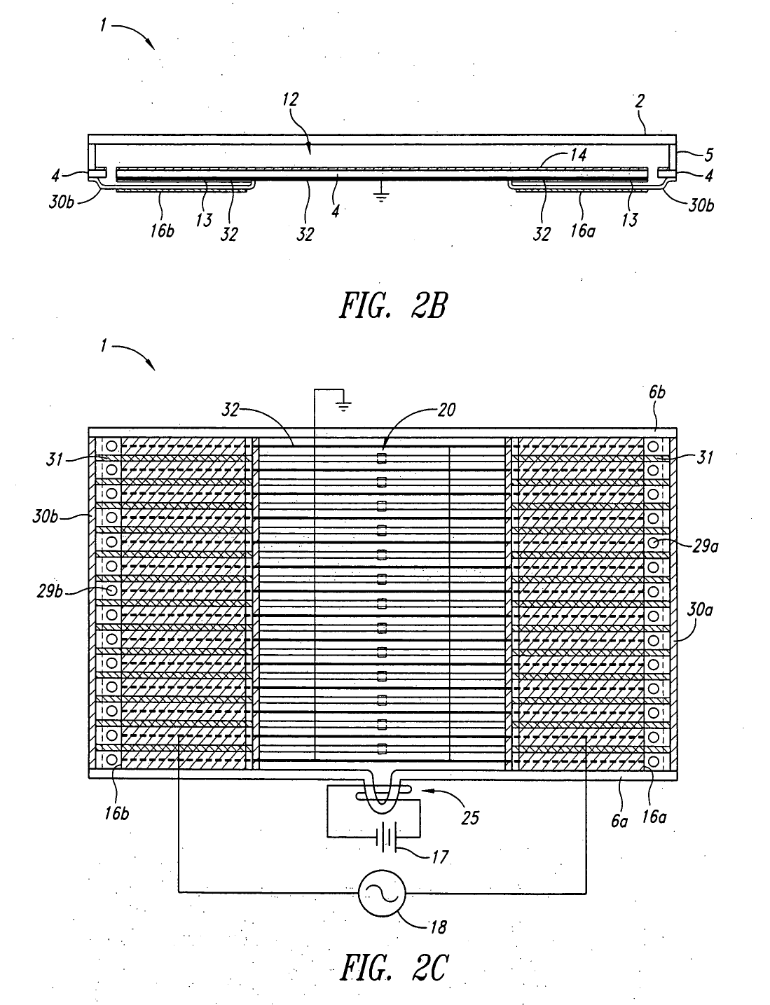

FIG. 2A shows an isometric view of a fluorescent lamp 1 without showing sidewalls 6a, 6b to provide a view of two sets of holes 29a, 29b penetrating a bottom plate 4, and at least a partially removed photoluminescent layer 14, which forms a gas permeable passage 20, according to one embodiment. FIG. 2B shows a cross section of the lamp 1 of FIG. 2A while FIG. 2C shows a bottom view of the lamp 1 of FIG. 2A having a tip-off tube 25. Reference is now made to FIGS. 2A-2C.

The lamp 1 of FIGS. 2A-2C is similar in some respects to the lamp of FIGS. 1A-1C. Hence, identical or similar elements or components will be identified by the same reference numbers. Only significant differences in structure and operation are discussed below.

The lamp 1 allows for mass production by having two sets of holes 29a, 29b formed through the bottom plate 4 with the gas permeable passage 20 formed by the removal of at least the photoluminescent material 14 underlying each of the electrically insulating partitions 10 at a position along a region 21 (described in detail in FIG. 3) of least electrical energy throughout each of the plurality of channels 12. The two sets of holes 29a and 29b are enveloped with extruding coverings 30a and 30b, respectively, on the backside of the lamp 1 and are disposed along the directional axis that is perpendicular to the channels 12.

Extruding coverings 30a and 30b have electrode plates 16a and 16b, respectively, disposed along the outside or inside (not shown) of the extruding covering 30a, 30b along the directional axis perpendicular to the channels 12. The insulating dividers 31 are disposed within the coverings 30a, 30b to electrically divide the electrode plates 16a, 16b so that each channel 12 is electrically isolated from the other.

The production of the lamp 1 of FIGS. 2A-2C is similar in some respects to the lamp 1 of FIGS. 1A-1C. Hence, only significant differences in production are discussed below.

The sets of holes 29a, 29b may be formed using the torch or a laser when the bottom plate 4 is hot, by drilling when the bottom plate 4 is cold, or by other suitable techniques known in the art. The gas permeable passage 20 may be formed using any suitable masking technique. A mask may be applied prior to deposition of the photoluminescent material 14 so that only the desired portions of the bottom plate 4 are covered with the photoluminescent material 14. Alternatively, mechanically scraping or removing the photoluminescent material 14 from the desired portions of the bottom plate 4 may form the passage 20. The coverings 30a, 30b are sealed onto the bottom plate 4 using the torch or low-melting point frit. One of the sidewalls 6a, 6b has at least one unsealed opening adjacent the passage 20, which is inserted with a pumping tube for extracting air from the lamp 1 by means of vacuum pumping. Following the vacuum pumping, the pumping tube fills the lamp 1 with the desired gas. As the pumping tube is removed from the sidewall 6a, 6b opening, the tip-off tube 25 is formed.

FIG. 3 shows a top view of a schematic illustration of electron flow within the channels 12 of the lamp 1 and electrodes 16 disposed within each of the channels 12 at opposite ends, according to one embodiment.

Power is supplied to the electrodes 16a, 16b (collectively referenced as 16 and individually referenced as 16a, 16b) disposed adjacent each of the plurality of channels 12 and at opposite ends of the channels 12 to create respective electrical discharge paths within the gas of each channel 12. In some embodiments, the electrodes 16 are disposed adjacent the channels 12 on the backside of the lamp 1 while in other embodiments, alternatively or additionally, the electrodes 16 are disposed within the channel 12. The electrodes 16 may be anodes/cathodes, filaments (e.g., heated electrodes or hot cathodes as shown in FIG. 3) or a combination thereof, which may be located within the channel 12, on the surface of the top plate 2, or on the surface of the bottom plate 4.

The powered electrodes 16 create the electrical discharge 19 within each of the channels 12 when the voltage across the channel 12 rises above a threshold value, called the breakdown voltage. Electrons are generated and emitted from each of the electrodes 16 within the channels 12, thereby forming the electrical discharge 19. The electrical discharge 19 is sustained by a flow of electrons generated by electrodes 16a, 16b, which operate alternatively as cathode and anode during AC operation. Since the electrical discharge 19 are on opposed sides of the channel 12 and flowing in opposite directions, there exists at least a portion of the region 21 within each of the channels 12 where the electrical energy is of minimal electrical energy in comparison to other locations within the channel 12. The phenomena known as space charge effect produces a voltage drop across the plurality of channels 12 within the lamp 1 causing the atmosphere in the chamber to conduct, which accelerates electrons, thus changing the electrical energy into kinetic energy and forming a plasma gas. The excitation of the plasma gas, which includes the ultraviolet emissive gas, causes the gas to emit ultraviolet radiation, which illuminates the photoluminescent material 14.

The electrical discharge 19 through the channels 12 excite the ultraviolet emissive gas molecules within the respective channels 12, thereby forming plasma gas. To ensure that the electrical discharge 19 is maintained within each channel 12 without flowing into an adjacent channel 12, the passage 20 is situated along the region 21 of least electrical energy for each of the plurality of channels 12, thereby ensuring that the path of least resistance is through the individual channel 12, namely, between the electrodes 16a and 16b, and not through adjacent channels 12, namely, not between the adjacent electrodes 16b and 16b. Therefore, the passage 20 atmospherically connects each of the plurality of chambers 12 along the region 21 of least electrical energy or high resistance while blocking the electrical discharge 19 between adjacent chambers 12.

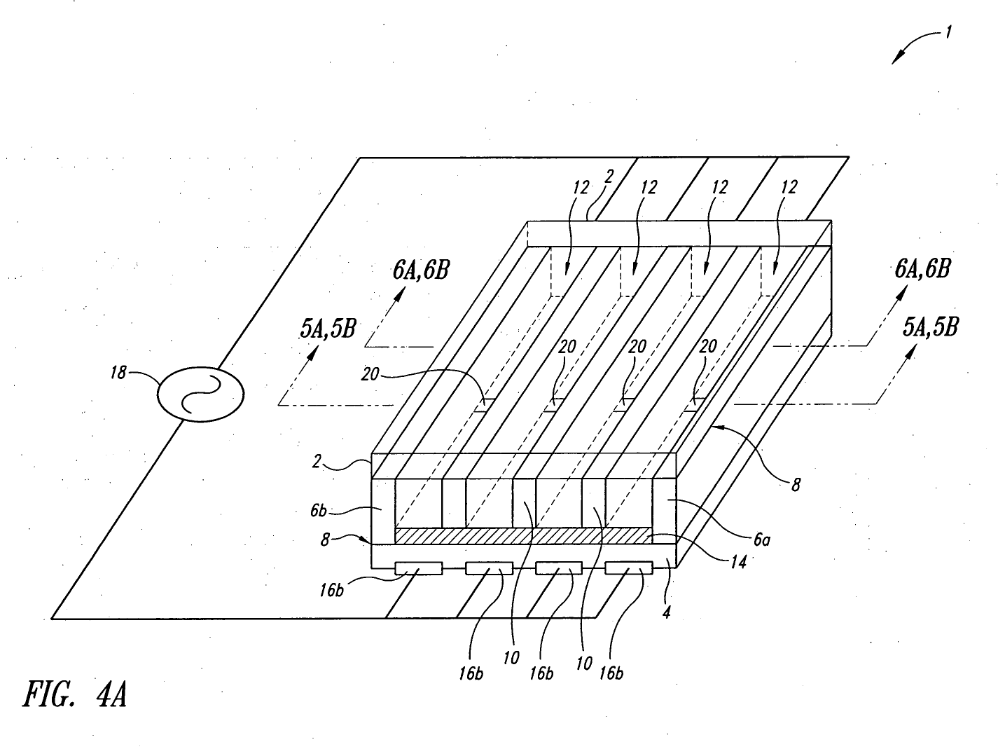

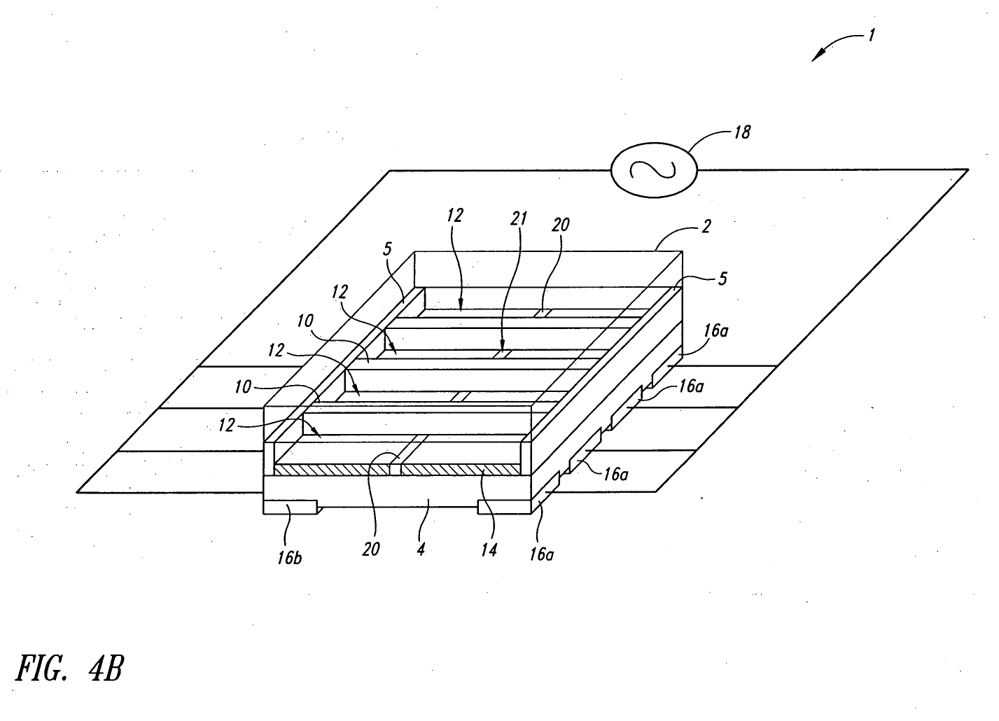

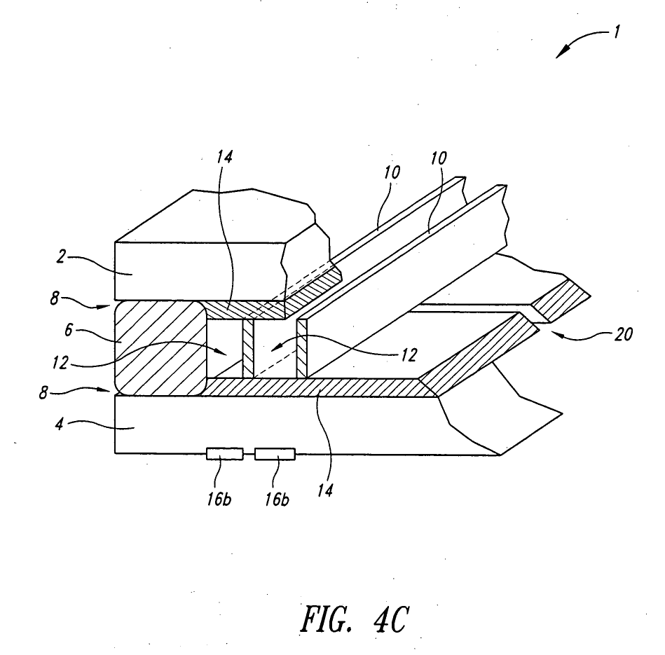

Referring jointly to FIGS. 4A and 4B, FIG. 4A shows an isometric view of a fluorescent lamp 1 showing sidewalls 6a, 6b without endwalls 5, to clearly view the plurality of channels 12 while FIG. 4B shows an isometric view of the lamp 1 showing the endwalls 5 without showing the sidewalls 6a, 6b of FIG. 4A to clearly view the gas permeable passage 20, according to one embodiment.

The lamp 1 of FIGS. 4A and 4B is similar in some respects to the lamp of FIGS. 1A-2A. Hence, identical or similar elements or components will be identified by the same reference numbers. Only significant differences in structure are discussed below.

The inner surface of the bottom plate 4 is coated with the photoluminescent coatings 14, as is known in the fluorescent tubular lamp industry. The electrodes 16a, 16b are disposed on the backside of the bottom plate 4 at opposite ends of each of the channels 12 in order to form the discharge path within the channel 12. The electrodes 16a, 16b are separate electrode entities that extend along a portion of each one of the channels 12. The electrical discharge 19 is blocked between the channels 12 while the channels 12 are atmospherically connected along the region 21 of least electrical energy via the gas permeable passage 20.

FIG. 4C shows an enlarged fragmentary cut away schematic of the fluorescent lamp 1, according to one embodiment. The passage 20 may be a connection through a midway region of each of the channels 12. The features of FIG. 4 are not to scale. Some features are enlarged and others reduced to provide a better view of the lamp 1.

According to the embodiments illustrated in FIGS. 1-4, the gas permeable passage 20 is created by the removal of at least the photoluminescent material 14 underlying the partitions 10 at positions along the region 21 of least electrical energy. The gas permeable passage 20 provides a passageway for gas, as well as vapor (e.g., mercury vapor), between adjacent channels 12. Alternatively, the passage may be formed during the deposition of the photoluminescent material 14 by depositing the material 14 only on inner surfaces of the plates 2, 4 that do not correspond to the region 21 of least electrical energy. Such selective deposition may be implemented using any one of several masking techniques known in the art. The partitions 10 are placed on the plate 14 after the selective formation or removal of the phosphor layer 14 at selected locations, so that the gas permeable passage 20 is provided.

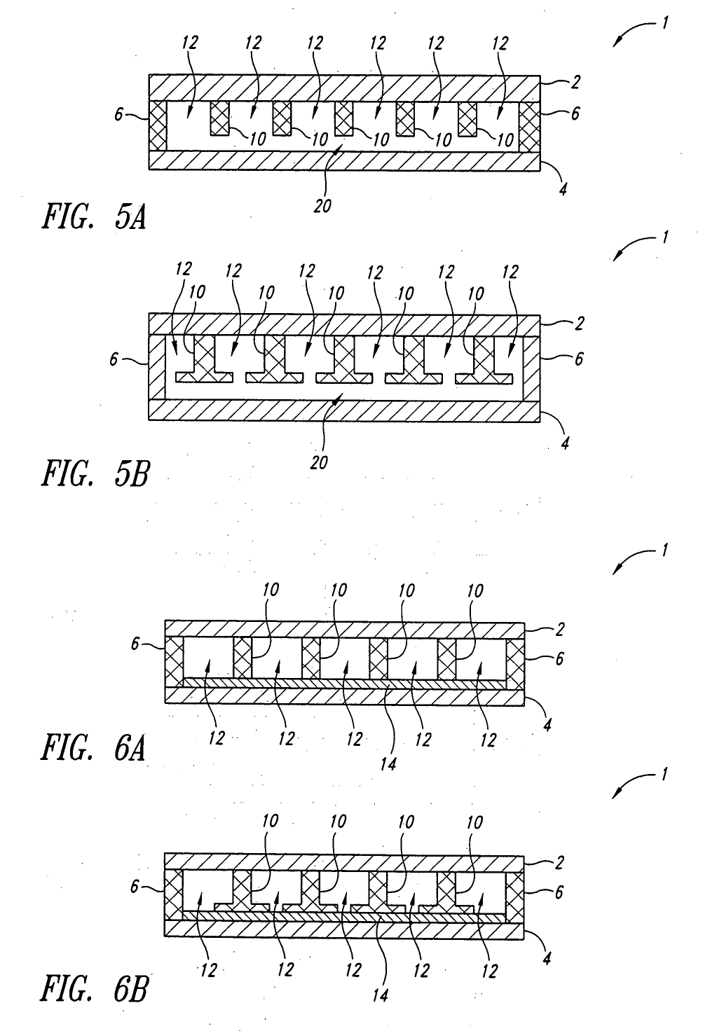

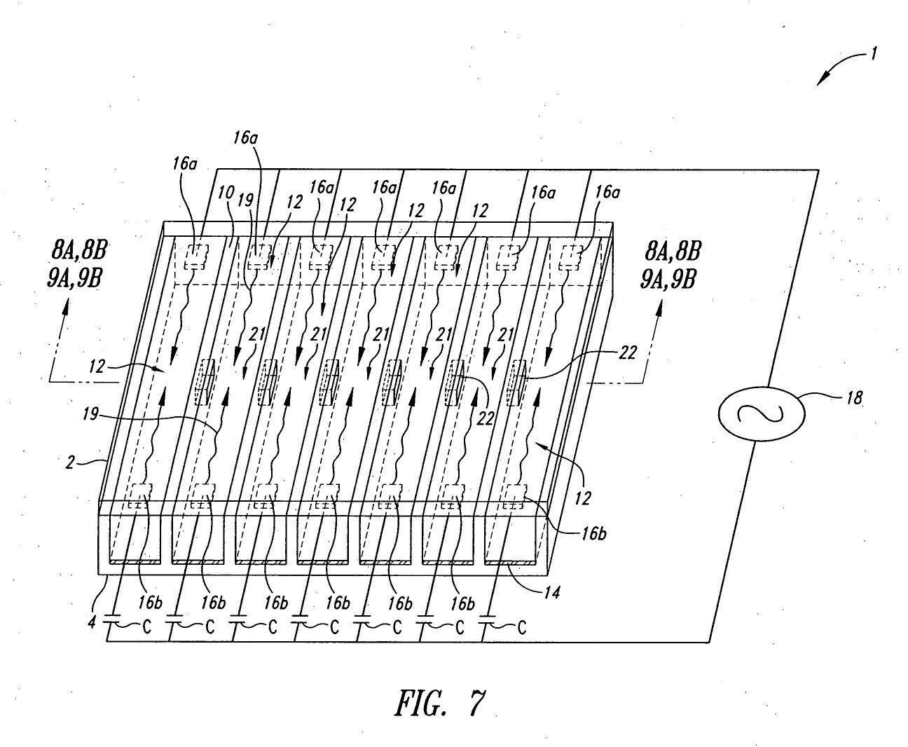

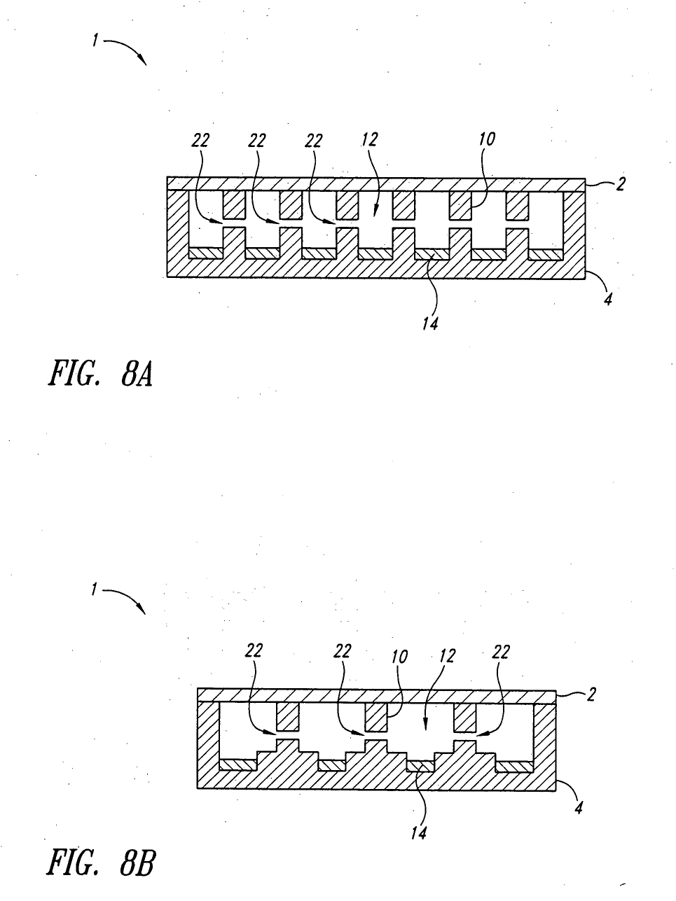

Embodiments of the fluorescent lamp 1 may comprise electrically insulating partitions 10 of various shapes and sizes. Examples of such embodiments are shown in FIGS. 5A and 5B at the location shown in FIG. 4A. The cross-sections depicted in FIGS. 5A and 5B show the gas permeable passage 20 positioned between adjacent channels 12 to permit a passage of plasma gas molecules and/or vapor between the adjacent channels 12 throughout the lamp 1. The cross sectional regions within the plurality of channels 12 depicted are parts of the region 21, which is of least electrical energy. The region 21 may be located midway the electrodes 16a, 16b, which are disposed on opposed ends of the channel 12. The cross sections depicted in FIGS. 6A and 6B show cross sectional views at different locations within the plurality of channels 12 as shown in FIG. 4A. It is obvious to those skilled in the art that the electrically insulating partitions 10 may take a variety of shapes and sizes. The electrically insulating partitions 10 are not to be limited to the shapes or sizes illustrated in the Figures.

FIG. 7 shows an isometric illustration of the lamp 1 having the gas permeable passage 20 formed through the electrically insulating partitions 10 and the electrodes 16a, 16b disposed within the channels 12, according to one embodiment.

The lamp 1 is similar in some respects to the lamp 1 of FIGS. 1-6. Hence, identical or similar elements or components will be identified by the same reference numbers. Only significant differences in structure and operation are discussed below.

The lamp 1 comprises the top plate 2 and the bottom plate 4, the bottom plate 4 shaped to include the partitions 10 and the sidewalls 6 as a portion of the bottom plate 4.

According to some embodiments, the gas permeable passage 20 may take the form of a plurality of apertures 22 in the plurality of partitions 10. The apertures 22 may be openings or windows of various shapes and sizes within the electrically insulating partitions 10 and positioned between adjacent channels 12. The apertures 22 permit the passage of gas molecules and/or vapor between the adjacent channels 12 while the electrical discharge 19 between the channels 12 is blocked. Similarly to the passage 20 discussed above in FIGS. 1-5, the plurality of apertures 22 are disposed within each partition 10 and positioned along the region 21 within each channel 12 that is of least electrical energy with respect to other areas within the channel 12. The positioning of the apertures 22 thereby ensure that the discharge path of least resistance is through the individual channel 12, namely, between the spaced electrodes 16a and 16b and not through adjacent channels 12, namely, not between the adjacent electrodes 16a and 16a. Therefore, by having the plurality of apertures 22 arranged along the region 21 of least electrical energy or high resistance, the electrical discharge 19 between the channels 12 is blocked while the channels 12 are atmospherically connected.

The gas pressure throughout the channels 12 may become equalized while the vapor pressure (e.g., mercury vapor pressure) varies between the channels 12. Since the conductivity of the channels 12 are affected by the vapor pressure and cathodes, one channel 12 may have higher conductivity and electrical discharge 19 than another channel 12. Thus, a ballasting capacitor C is connected in series between each of the electrodes 16b and the power supply 18. Each capacitor C limits the amount of current or electrical discharge 19 that may flow within the associated channel 12, thereby assuring uniform illumination between the plurality of channels 12.

FIGS. 8A and 8B show cross-sections of the lamp 1 of FIG. 7, according to various embodiments.

The embodiments of the fluorescent lamp 1 may comprise electrically insulating partitions 10 of various shapes and sizes. Examples of such embodiments are shown in FIGS. 8A and 8B, not drawn to scale. The cross sections depicted in FIGS. 8A-8B show the gas permeable passage 20 in the form of the plurality of apertures 22 within the electrically insulating partitions 10 and positioned between adjacent channels 12. The apertures 22 permit a passage of plasma gas molecules and/or vapor between the adjacent channels 12. The cross sectional regions depicted within the plurality of channels 12 are regions of least electrical energy. Such a region may be located midway the electrodes 16a, 16b, which are disposed on opposed ends of the channel 12.

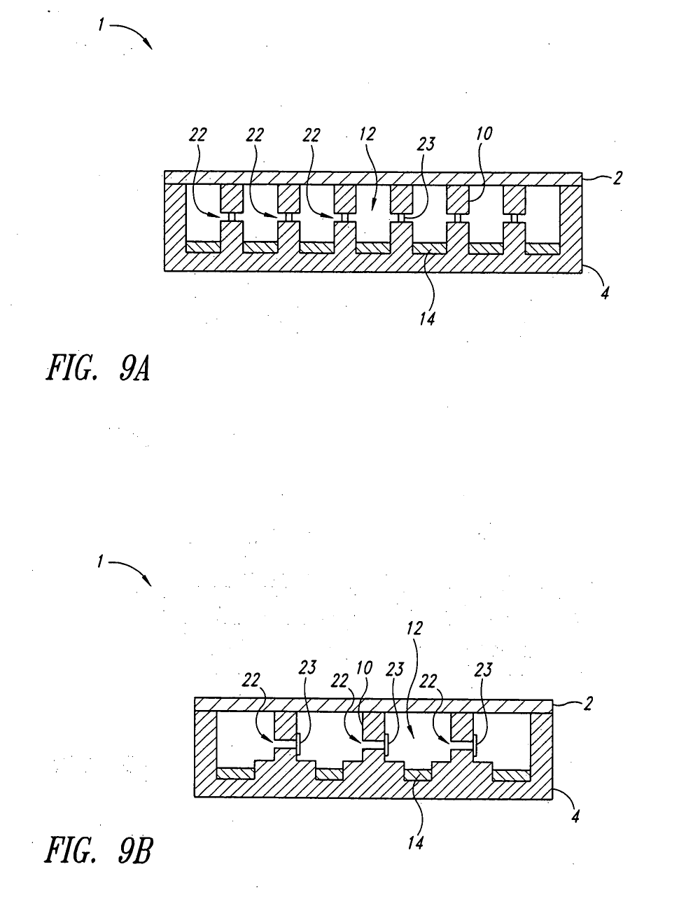

FIGS. 9A-9B show cross sections of the lamp 1 of FIG. 7 having a plurality of gas permeable membranes 23, according to some embodiments.

As discussed above, the electrically insulating partitions 10 may be of various shapes and sizes. Each of the plurality of gas permeable membranes 23 is disposed to cover the aperture 22 between adjacent channels 12. The membranes 23 serve as a selective passageway allowing gas molecules and the like to pass, while blocking other components from passing through the membrane 23. The plurality of gas permeable membranes 23 covering the apertures 22 serve a similar function as a selective gas permeable passage 20. The membrane 23 can be on the wall of partitions 10, to cover the aperture 22, or can be within the apertures 22.

The gas permeable membranes 23 are electrically insulating, thus ensuring that the electrical discharge 19 is maintained within each of the channels 12 and does not pass through the membranes 23 and into adjacent channels 12. Accordingly, the membranes 23 may be located at various positions between the channels 12 and need not be arranged along the region 21 of least electrical energy. In some embodiments, the membranes 23 are gas permeable and do not pass vapor (e.g., mercury vapor), while in other embodiments, the membranes 23 pass both gas and vapor (e.g., mercury vapor).

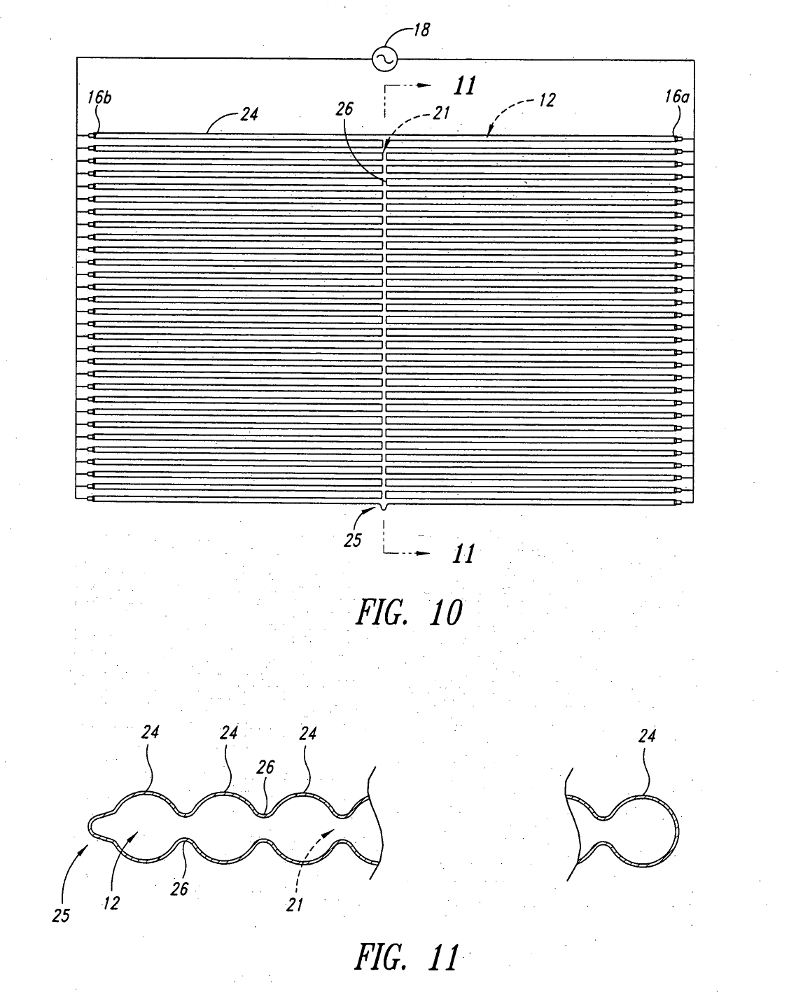

FIG. 10 shows a schematic illustration of the fluorescent lamp 1 with electrical discharge 19 within gas filled tubes 24, according to another embodiment.

According to one embodiment, the lamp 1 comprises the plurality of discharge channels 12 in the form of a plurality of individual fluorescent phosphor coated or colored glass tubes 24. For example, each three tubes could be respectively coated with red, green and blue phosphor or wavelength filtered by the glass itself, as is known in the art. Each of the tubes 24 is an individual chamber with an inner coating of photoluminescent material 14 such as, for example, phosphor that generates visible light energy in response to excitation via ultraviolet radiation. The plurality of tubes 24 are of electrically insulating material similar to that of the electrically insulating partitions 10 and may be spaced from each other or may be in direct contact with the adjacent tube 24.

Each of the tubes 24 includes the ultra violet emissive gas such as, for example, mercury vapor. As described above, while mercury vapor is commonly used in fluorescent lamps, it is possible to use other materials and gases such as, for example, krypton, argon, xenon, a mixture of inert halogen gases and the like, either alone or in combination to produce the desired spectral characteristics, all of which are known to those skilled in the art. Similarly to FIGS. 1-9, the ultraviolet emissive gas emits UV radiation when the gas is electrically excited. Additionally, it is permitted to vary the lamp 1 pressure to alter the spectral characteristics of the lamp 1 for a given gas.

Power is supplied to the plurality of electrodes 16 disposed adjacent each of the tubes 24 to create electrical discharge 19 within the gas of each tube 24. The electrodes 16 may be anodes/cathodes, filaments or a combination of the two. In some embodiments, the AC power supply 18 may power the electrodes 16 while in other embodiments the DC power supply may be converted to AC power at a selected frequency. The powered electrodes 16 create the electrical discharge 19 within each of the tubes 24 when the voltage across the tube 24 rises above a threshold value. The electrical discharge 19 and the region 21 of least electrical energy are as described in detail above.

According to one embodiment, the gas permeable passage 20 takes the form of a plurality of vias 26 linking the plurality of tubes 24. The via 26 permits the passage of gas molecules and/or vapor between adjacent tubes 24 while the electrical discharge 19 between the tubes 24 is blocked. The electrical discharge 19 within each individual tube 24 excites the ultraviolet emissive gas molecules within the tube 24, thereby forming the plasma in the gas. To ensure that the electrical discharge 19 within each tube 24 flows throughout the tube 24 without flowing through the via 26 and into an adjacent tube 24, the vias 26 are situated at locations along the region 21 of least electrical energy for each of the plurality of tubes 24, thereby ensuring that the path of least resistance is through the individual tube 24 (e.g., between the electrodes 16a and 16b) and not through adjacent tubes 24 (e.g., between the electrodes 16a and 16a). Thus, the plurality of vias 26 atmospherically connect each of the tubes 24 along the region 21 of least electrical energy or high resistance while blocking the electrical discharge 19 between adjacent tubes 24.

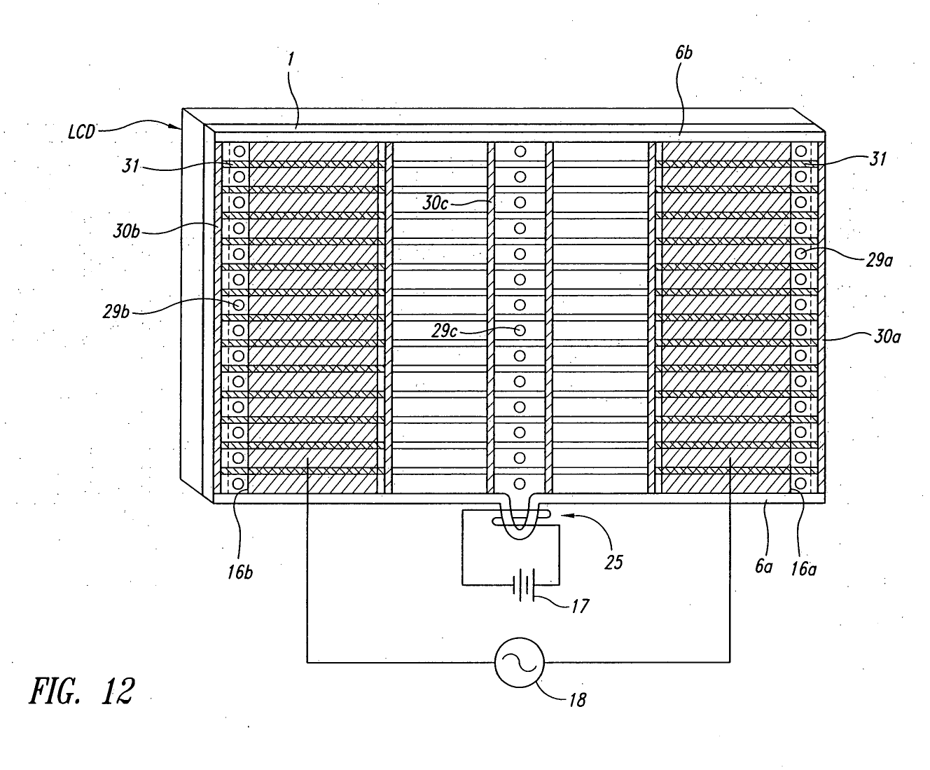

FIG. 11 shows a cross section schematic of the lamp 1 of FIG. 10, according to one embodiment.

Embodiments of the lamp 1 may comprise electrically insulating partitions 10 in the form of the plurality of tubes 24, which may take the form of various shapes and sizes. An example of such is shown in FIG. 11. The cross section shows the plurality of vias 26 linking the plurality of tubes 24 along the region 21 of least electrical energy. The vias 26 permit the passage of less excited gas molecules between adjacent tubes 24 while the electrical discharge 19 is substantially blocked therebetween. The cross sectional regions within the plurality of tubes 24 depicted in FIG. 11 are part of the region 21 of least electrical energy.

Therefore in conclusion, the fluorescent lamp 1 with its plurality of individual discharge channels 12 provides shorter paths for electrical discharge 19 in comparison to the prior art (serpentine structure). Shorter paths for electrical discharge 19 require lower electrode voltages to ionize the ultraviolet emissive gas. The fluorescent lamp 1 is scaleable to larger sizes without having to dramatically increase the voltage across the long channels 12, simply by adding more discharge channels 12 with electrodes 16 disposed on opposite ends. Thus, the lamp 1 may be specifically sized to function as a backlight for a variety of LCD television sets, as shown in FIG. 12. The discharge channels 12 may come in a variety of shapes and sizes such as, for example, one or more tubes 24 as described above.

The fluorescent lamp 1 further includes a means for allowing the passage of plasma gas molecules between the plurality of channels 12 to permit uniform gas pressure throughout the plurality of channels 12 while maintaining separate electrical discharge 19 within each channel 12. Uniform gas pressure throughout all channels 12 comprising the lamp 1 provides a uniform display across the entire lamp 1, which is essential in many display applications such as, for example, flat-screen televisions.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. A lamp comprising:
a plurality of channels filled with a gas;
electrodes disposed adjacent each of the plurality of channels to create respective paths for electrical discharge within the gas of each channel; and
a gas permeable passage positioned between adjacent channels that permits passage of gas molecules between the adjacent channels while the electrical discharge is blocked between the plurality of channels.

2. The lamp according to claim 1 wherein the plurality of channels are further filled with a vapor.

3. The lamp according to claim 2 wherein the vapor is mercury vapor.

4. The lamp according to claim 2 wherein the gas permeable passage further permits the passage of the vapor between the adjacent channels.

5. The lamp according to claim 1, further comprising:
a first and a second planar plate defining a top and a bottom enclosure for each of the plurality of channels; and
a plurality of insulating sidewalls coupled to peripheral edges of the first and the second planar plate thereby forming a hermetic chamber including a plurality of electrically insulating partitions, which designate the plurality of channels, extending between the first and the second plate.

6. The lamp according to claim 5 wherein the first and the second planar plate, the plurality of insulating sidewalls and the plurality of electrically insulating partitions comprise one unit of glass.

7. The lamp according to claim 6, further comprising:
a photoluminescent material applied to an inner surface of at least one of the first and second planar plates defining the top and bottom enclosures for each of the plurality of channels and/or to the surfaces of the electrically insulating partitions within the hermetic chamber wherein the photoluminescent material luminesces in response to ionization of the gas due to electron flow within the chambers.

8. The lamp according to claim 7, further comprising:
a first and second set of holes formed through the bottom enclosure proximate each end of the channels; and
a first and a second extruding covering overlying the first and second set of holes, respectively, wherein the first and second extruding coverings are disposed along a directional axis that is perpendicular to the channels.

9. The lamp according to claim 8 wherein the electrodes take a form of a first and a second electrode plate disposed adjacent the first and the second extruding covering, respectively.

10. The lamp according to claim 9, further comprising a third set of holes having a third extruding covering wherein the third set of holes is formed through the bottom enclosure and forms the gas permeable passage.

11. The lamp according to claim 9, further comprising at least a removed portion of the photoluminescent material underlying each of the plurality of electrically insulating partitions at a position along a region of least electrical energy, thereby forming the gas permeable passage.

12. The lamp according to claim 9 wherein the gas permeable passage is an aperture between the chambers along a region of least electrical energy.

13. The lamp according to claim 9 wherein the gas permeable passage is a tube that atmospherically connects each of the plurality of channels along a region of least electrical energy.

14. The lamp according to claim 13 wherein the tube takes a form of a removal of the photoluminescent material along the region of least electrical energy throughout each of the plurality of channels.

15. The lamp according to claim 14 wherein the region of least electrical energy is a midway region through each of the plurality of channels.

16. A lamp, comprising:
a plurality of channels filled with a gas;
means for creating paths for electrical discharge within the respective plurality of channels; and
means for permitting a passage of gas molecules between adjacent channels while the electrical discharge is blocked between the plurality of channels.

17. The lamp according to claim 16 wherein the plurality of channels are further filled with a vapor.

18. The lamp according to claim 17 wherein the vapor is mercury vapor.

19. The lamp according to claim 16 wherein the means for permitting the passage of gas molecules further permits the passage of vapor between adjacent channels.

20. A method for providing uniform illumination across a lamp comprising:
blocking electrical discharge between a plurality of channels; and
atmospherically connecting the plurality of channels to permit a passage of gas molecules between adjacent channels.

21. The method according to claim 20 wherein blocking the electrical discharge includes forming a plurality of electrically insulating partitions.

22. The method according to claim 20 wherein atmospherically connecting the plurality of channels further permits a passage of vapor between adjacent channels.

23. The method according to claim 20 wherein atmospherically connecting the plurality of channels includes creating a gas and/or vapor permeable passage.

24. The method according to claim 20 wherein atmospherically connecting the plurality of channels includes creating an aperture within each of the plurality of electrically insulating partitions along a region of least electrical energy.

25. The method according to claim 24 wherein creating the aperture within each of the plurality of electrically insulating partitions includes covering the aperture with an electrically insulating membrane that is gas and/or vapor permeable.

26. The method according to claim 24 wherein creating the aperture within each of the plurality of electrically insulating partitions includes disposing within the aperture an electrically insulating membrane that is gas and/or vapor permeable.

27. The method according to claim 20 wherein atmospherically connecting the plurality of channels includes forming a tube along a region of least electrical energy.

28. The method of claim 27 wherein forming the tube includes removing portions of a layer of photoluminescent material along the region of least electrical energy throughout each of the plurality of channels.

29. The method of claim 20 wherein atmospherically connecting the plurality of channels includes removing at least the photoluminescent material underlying each partition at a position along a region of least electrical energy.
